(19) United States
(12) Patent Application Publication
(10) Pub. No.: US 2005/0256235 A1
(43) Pub. Date: Nov. 17, 2005

(54) Stabilized environmentally sensitive binders

(76) Inventors: Kenneth Tseng, Lawrenceville, NJ (US); Scot Swan, King of Prussia, PA (US); David Mountz, Exton, PA (US); Mark Aubart, Malvern, PA (US); Gary Silverman, Chadds Ford, PA (US)

Correspondence Address: Arkema Inc., 2000 Market St., Philadelphia, PA, 19103, US

(21) Appl. No.: 11/117,091

(22) Filed: Apr. 28, 2005

Related U.S. Application Data
(60) Provisional application No. 60/569,942, filed on May 11, 2004.

(51) Int. Cl. C08K 5/09

(52) U.S. Cl. 524/284

(57) ABSTRACT

The present invention relates to environmentally sensitive organic binders stabilized by maleic anhydride and its derivatives. The unstabilized binders can rapidly hydrolyze and thicken when exposed to the environment, and especially to moisture. Maleic anhydride and its derivatives act to stabilize these binders. The stabilized organic binders of the invention are especially useful for forming marine antifoulant coatings.

This application claims benefit under U.S.C. §119(e) of U.S. provisional application 60/569,942, filed May 11, 2004.

### FIELD OF THE INVENTION

The present invention relates to environmentally sensitive organic binders stabilized by maleic anhydride and its derivatives. The unstabilized binders can rapidly hydrolyze and thicken when exposed to the environment, and especially to moisture. Maleic anhydride and its derivatives act to stabilize these binders. The stabilized organic binders of the invention are especially useful for formulating marine antifoulant coatings.

### BACKGROUND OF THE INVENTION

Polymers containing hydrolysable groups, especially hydrolysable carboxylic ester groups have been shown to offer excellent self-polishing performance in marine antifoulant coatings. One problem experienced with these coatings is poor shelf stability due to exposure to moisture and incompatibility with Zn compounds. Once exposed to air and moisture, the viscosity tends to increase rapidly resulting in a thick mass within a month. In addition, the moisture content of different coating additives and acid co-binders, such as rosin acid, further contributes to poor shelf stability, as do additives such as cuprous oxides, organic booster biocides, and other additives.

Several methods are known which reduce the moisture content of a coating formulation containing hydrolysable copolymers, and thus improve shelf stability. One such method is to add an organic or inorganic dehydrating agent. U.S. Pat. Nos. 6,458,878; 6,172,132; and 6,110,990 describe the use of anhydrous gypsum (CaSO₄), synthetic zeolites such as molecular sieves, orthoesters such as methyl orthoformate and methyl orthoacetate, orthoboric esters, silicates, and isocyanates.

U.S. Pat. No. 4,187,211, describes the use of a relatively inert and water insoluble dehydrating agent used in triorganotin antifoulant paints to inhibit viscosity increase. In U.S. Pat. Nos. 5,342,437; 5,252,123; 5,232,493; 5,185,033; 5,112,397; 5,098,473, natural and synthetic clays (e.g. betonite) and desiccants (e.g. molecular sieves, alumina) were effective to increase storage stability by removing moisture in paints containing zinc pyrithione and copper oxide.

Chelating agents have been used to stabilize antifoulant paints containing acrylic, polyester, or silyl resins. EP 1 033 392 describes the use of chelating agents such as beta-diketones, esters of acetoacetic acid, alpha-dioximes, bipyridyls, oximes, alkanolamines, glycols, salicylic acid and derivatives thereof, and organic acids. These chelating agents prevent the viscosity increase and deterioration of coating properties observed when copper antifoulant additives are added to the paint.

Monoamine and quaternary ammonium compounds have been described for increasing the storage stability of antifoulant paints containing binders with organosilyl functional groups in WO 91/14743. The compounds inhibit paint gelation caused by using antifoulant agents that contain copper or zinc. Diterpene-containing amines are used as marine paint binder and biocide in U.S. Pat. No. 5,116,407.

U.S. Pat. No. 4,376,181 discloses the use of hindered phenols, such as 2,6-di-tert-butylphenol, to reduce the viscosity increase observed in the storage of antifoulant paints containing cuprous oxide and triorganotin-containing polymers.

Triazole derivatives, thiadiazole derivatives, and benzothiazole derivatives have been described in U.S. Pat. No. 5,773,508 as stabilizers of antifoulant paints containing unsaturated acid anhydrides. These derivatives prevent the increase in viscosity observed when the antifoulant paints contain copper compounds.

Trace amounts of organic acids, and acid anhydrides are known sources of stability problems in antifoulant paints. U.S. Pat. No. 4,547,532 discloses that traces of water and the presence of trace acid are causes of stability problems in many antifoulant paints. U.S. Pat. Nos. 5,439,511, and 5,773,508 disclose copolymers for antifoulant coatings using an acid anhydride monomer. The antifoulant coating compositions are formed from an acid anhydride and another unsaturated monomer, and stabilized with an additive selected from triazole derivatives, thiadiazole derivatives, benzothiazole derivatives, polyethers, and carboxylic acid anhydride derivatives. While exemplifying succinic anhydride and itaconic anhydride as stability additives, this reference teaches that when part of the acid anhydride monomer (preferably maleic anhydride) remains unreacted and free in the formulation, it tends to cause an adverse effect to the stability of the coating. Thus the reference teaches away from the presence in the final formulation of maleic anhydride.

It was found that following high speed mixing without climate control, the coating composition developed a thin skin in one day, and gelled in 2-3 days. While not being bound by any particular theory, the hydrolyzable groups of the polymer could become very reactive (sensitive) towards moisture in air or to additives (such as thixotropes, Cu₂O, and biocides), under these conditions. These conditions, along with the presence of metal ions (Zn and Cu), may be the cause of formation of a layer of skin at the air/liquid interface. Gradually, the layer of skin becomes thicker, and the coating gels completely.

Surprisingly it has been found that maleic anhydrides provide excellent stabilization for hydrolyzable organic binders, even under high shear mixing conditions. Despite negative effects on binder stability attributed to maleic anhydride in the art, it has now been found that such negative effects are overcome by the positive stability effects under high shear mixing applications.

### SUMMARY OF THE INVENTION

An object of the invention is to identify and optimize effective stabilizers for environmentally sensitive binder compositions.

It is a further objective to identify and optimize an effective stabilizer for environmentally sensitive binder compositions, which do not lead to skinning and gelation under high speed mixing.

These objectives have been met by the present invention of a stabilized coating composition comprising:
a) one or more environmentally sensitive binders; and
b) 0.1 to 10 percent by weight of one or more stabilizers selected from the group consisting of maleic anhydride or a maleic anhydride derivative.

### DETAILED DESCRIPTION OF THE INVENTION

This invention discloses maleic anhydride and its derivatives as effective stabilizers to inhibit the viscosity increase of environmentally sensitive binders and their formulated coatings, especially marine antifoulant paints.

By an “environmentally sensitive binder”, as used herein, is meant that the copolymer binder may undergo hydrolysis to form an acid. The hydrolysis may be catalyzed by the presence of metals found in common additives in coating compositions. The copolymer may react with moisture (free water molecules, or physically bounded hydrates) in air, or in raw materials.

As used herein, the term “copolymer” includes polymers comprising two or more different monomeric units. The copolymers are random copolymers. The invention also includes mixtures of copolymers.

The present invention is applicable to all hydrolysable polymeric binders that upon hydrolysis generate acid, including but not limited to, —COOH, and other acid functional groups such as —SO₃H, —HₓPO_{4,} —Si(OH)ₓ, and —B(OH)ₓ.

Preferably the binder is an acrylic copolymer binder. The acrylic copolymer is a copolymer of silyl acrylate monomer and co-monomers, which can be either acrylic or vinyl monomers. The preferred % range of acrylic is 10% (for low silyl) to 99% (for all acrylic). Examples of acrylic monomers useful in the invention include, but are not limited to acrylic acids, esters of acrylic acids, acrylic amides, and acrylonitriles. It also includes alkacryl derivatives, and especially methacryl derivative. Functional acrylic monomers are also included. Examples of useful acrylic monomers include, but are not limited to esters of acrylic acid such as methyl acrylate, ethyl acrylate, propyl acrylate, n-butyl acrylate, t-butyl acrylate, sec-butyl acrylate, 2-ethylhexyl acrylate, cyclohexyl acrylate, phenyl acrylate, n-octyl acrylate, 2-hydroxyethyl acrylate, hydroxy-n-propyl acrylate, hydroxy-1-propyl acrylate, glycidyl acrylate, 2-methoxyethyl acrylate, 2-methoxypropyl acrylate, methoxytriethyleneglycol acrylate, 2-ethoxyethyl acrylate, ethoxydiethyleneglycol acrylate and the esters of methacrylic acid such as methylmethacrylate, ethyl methacrylate, propyl methacrylate, n-butyl methacrylate, t-butyl methacrylate, sec-butyl methacrylate, 2-ethylhexyl methacrylate, cyclohexyl methacrylate, 2-hydroxyethyl methacrylate, glycidyl methacrylate, 2-methoxyethyl methacrylate, 2-methoxypropyl methacrylate, methoxytriethyleneglycol methacrylate, and 2-ethoxyethyl methacrylate, hydroxy-n-propy(meth)acrylate, hydroxy-1-propyl methacrylate, phenoxyethyl methacrylate, butoxy ethyl methacrylate, isobornyl (meth)acrylate. Other useful ethylenically unsaturated monomers include neopentyl glycolmethylether propoxylate acrylate, poly(propylene glycol)methylether acrylate, ethoxydiethyleneglycol methacrylate, acrylic acid, methacrylic acid, 2-butoxyethyl acrylate, crotonic acid, di(ethylene glycol) 2-ethylhexyl ether acrylate, di(ethylene glyxol)methyl ether methacrylate, 3,3-dimethyl acrylic acid, 2-(dimethylamino)ethyl acrylate, 2-(dimethylamino)ethyl methacrylate, ethylene glycol phenyl ether acrylate, ethylene glycol phenyl ether methacrylate, 2 (5H)-furanone, hydroxybutyl methacrylate, methyl-2 (5H)-furanone, methyl trans-3-methoxyacrylate, 2-(t-butylamino)ethyl methacrylate, tetrahydrofurfuryl acrylate, 3 tris-(trimethylsiloxy)silyl propyl methacrylate, tiglic acid, and trans-2-hexenoic acid.

The acrylic monomer(s) are copolymerized with one or more other ethylenically unsaturated monomers. The properties of the copolymer can be tailored by the choice and ratio of comonomer(s). It is possible to adjust the hydrophilic or hydrophobic nature of the copolymer by choice of comonomer(s) used. Examples of monomers useful in forming the copolymer of the invention include, but are not limited to, vinyl esters such as vinyl acetate, vinyl propionate, vinyl butyrate, vinyl benzoate, maleic esters such as dimethyl maleate, diethyl maleate, di-n-propyl maleate, diisopropyl maleate, di-2-methoxyethyl maleate, fumaric esters such as dimethyl fumarate, diethyl fumarate, di-n-propyl fumarate, diisopropyl fumarate, styrene, vinyltoluene, alpha-methylstyrene, N,N-dimethyl acrylamide, N-t-butyl acrylamide, N-vinyl pyrrolidone, and acrylonitrile.

The acrylic binder of the invention may be a Cu and/or Zn acrylate binders of the formula:

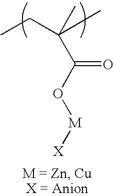

In a preferred embodiment, the acrylic polymer is an organosilyl acrylate polymer containing hydrolysable organo-silylester groups. Especially preferred are triarylsilyl(meth)acrylate-containing copolymers such as triphenylsilyl(meth)acrylate. Useful trialkylsilyl(meth)acrylates include trimethylsilyl(meth)acrylate, diphenylmethylsilyl(meth)acrylate, phenyldimethylsilyl(meth)acrylate triisopropylsilyl(meth)acrylate, and tributylsilyl(meth)acrylate.

The polymer binder of the present invention is prepared by polymerizing the acrylate monomer(s) with one or more ethylenically unsaturated monomers which are copolymerizable therewith. Specific monomers have been discovered to be useful in synthesizing terpolymers or higher polymers of the present invention to provide a polymer with improved properties such as film flexibility and crack resistance, which retain acceptable water erodibility.

The random copolymer binder can be obtained by polymerizing the mixture of monomers in the presence of a free-radical olefinic polymerization initiator or catalyst using any of various methods such as solution polymerization, bulk polymerization, emulsion polymerization, and suspension polymerization using methods well-known and widely used in the art. In preparing a coating composition from the copolymer, it is advantageous to dilute the copolymer with an organic solvent to obtain a polymer solution having a convenient viscosity. For this, it is desirable to employ the solution polymerization method or bulk polymerization method.

Examples of useful organic solvents include aromatic hydrocarbons such as high flash naphtha, xylene and toluene, aliphatic hydrocarbons such as hexane and heptane, esters such as ethyl acetate and butyl acetate, ethers such as dioxane and tetrahydrofuran, and ketones such as methyl ethyl ketone and methyl isobutyl ketone. The solvents are used either alone or in combination.

The desirable molecular weight of the acrylate copolymer is in the range of from 1,000 to 200,000, preferably from 10,000 to 150,000 in terms of weight-average molecular weight. Too low or too high molecular weight copolymers create difficulties in forming normal coating films. Too high molecular weights result in long, intertwined polymer chains that do not perform properly and result in viscous solutions that need to be thinned with solvent so that a single coating operation results in a thin film coating. It is advantageous that the viscosity of the solution of the copolymer is 200 to 6,000 centipoise at 25° C.

The environmentally sensitive binder is stabilized with one or more maleic anhydrides. By “maleic anhydrides”, or “maleic anhydride stabilizer” as used herein is meant maleic anhydride or one of its derivatives having the formula: 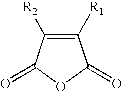
wherein R₁ and R₂ are independently a hydrogen, chlorine, bromine, methyl, ethyl or phenyl group. Examples include, but are not limited to, maleic anhydride, methylmaleic anhydride, dimethyl maleic anhydride, ethyl maleic anhydride, diethyl maleic anhydride, chloro maleic anhydride, dichloro maleic anhydride, bromo maleic anhydride, dibromo maleic anhydride, phenyl maleic anhydride. The preferred stabilizer is maleic anhydride.

The maleic anhydrides can be combined with the polymeric binder by means known in the art. The maleic anhydride stabilizer is combined at from 0.1 to 10 weight percent based on the coating composition, preferably from 0.5 to 5% weight percent. The maleic anhydride stabilizer may be used in conjunction with one or more stabilizers known in the art. In one embodiment, the maleic anhydride is admixed with the polymer binder solution. The maleic anhydrides can also be added directly to the paint formulation. On a commercial scale, the maleic anhydride, binder, and other additives are combined under high speed mixing. Other additives in the coating formulation may include, but are not limited to, one or more co-binders and/or additives such as rosin, pigments, stabilizers, drying agents, antisagging agents, plasticizers, dispersing agents, thixotropic agents, fillers, biocides (Cu₂O) and organic co-biocides, as known in the art.

The stabilized binder compositions may be used to fabricate self-polishing marine antifoulant paints. In general, the erosion rate of a self-polishing marine antifoulant paint is considered to be a function of the amount of hydrolysable monomer in the polymer. Indeed, U.S. Pat. No. 4,593,055, which discloses and claims seawater erodible silyl acrylate copolymers, teaches at Column 5, lines 43 et seq. that the superior control of the erosion rate relies on chemically tailoring the polymer so that it is selectively weakened at certain points pendant to the polymer chain at the paint/water interface. These weak links are slowly attacked by seawater allowing the polymer to gradually become seawater soluble or seawater swellable. This weakens the hydrolyzed surface polymer film to such an extent that moving sea water is able to wash off this layer and thus expose a fresh surface.

A portion of the monomeric units provides functional groups that provide a site of weakness, that is, sites that tend to hydrolyze in the presence of seawater. The ratio of functionalized monomers to non-functionalized monomers is selected to provide control of the erosion rate.

The stabilized coating composition of the present invention may be used to coat structures exposed to marine, freshwater, or brackish water.

While not being bound by any particular theory, it is believed that the maleic anhydride may function as more than just a stabilizer. It could also enhance the erosion of silyl acrylate coatings. In the slow erosion of silyl acrylate binder in the self-polishing mechanism, rosin is used to bring water into the close proximity of silyl ester groups. The maleic anhydride may participate in causing the optimum erosion rate of the antifoulant paints.

### EXAMPLES

An accelerated storage stability test was run according to the following procedure: 1) Fill a small paint can (½ to 1 pint size) with a liquid test sample and leave at least ¼″ air space on top. 2) Record the initial viscosity, and seal the can properly with a lid. 3) Place the can into an oven at 55° C. 4) Record the viscosity weekly and inspect the paint consistency. 5) Terminate the test if the sample develops lumps or gels before 8 weeks. 6) Continue the test for 8 weeks. 7) Judge based on a Pass/Fail criteria of no skinning or gelling. All viscosity measurements were done at 25° C. using a Brookfield RVT viscometer. Note that an asterisk in the tables below indicates that the sample gelled and a measurement of the viscosity was not possible. Under these conditions, a tributyltin copolymer passes after 8 weeks at 55° C. This increase in viscosity for the tributyltin copolymer corresponds to 2 years of shelf life at room temperature.

### EXAMPLE 1 (COMPARATIVE)

Example 1 demonstrates the poor stability of paints prepared under high speed mixing using a silyl acrylate binder (poly(triphenylsilyl methacrylate-co-methyl methacrylate) in 50 wt % xylene solution) stabilized with 3 wt % dicyclohexyl carbodiimide. Without additional stabilizers such as molecular sieves or maleic anhydride, all the paints did not survive 8 weeks at 55° C. Formulations based on Bentone SD appear to be the most stable paints. Those based on Thixatrol had the poorest stability overall.

Silylacryalate binder (Atofina Chemicals, Inc.); MAP 60X: Polyethylene wax (Elementis); Nuosperse 657: Dispersing agent (Huls America, Inc.); TCP: tricrycyl phosphate (Aldrich); Bentone SD-2: Organo clay (Elementis).

TABLE 1
Test Formulations

| Ingredients | Ex 1.1 | Ex 1.2 | Ex 1.3 | Ex 1.4 | Ex 1.5 | Ex 1.6 | Ex 1.7 | Ex 1.8 |
|---|---|---|---|---|---|---|---|---|
| Stabilized silyl | 29.9 | 30.0 | 30.0 | 34.2 | 34.3 | 33.1 | 34.3 | 34.3 |
| acrylate binder | | | | | | | | |
| NuoSperse 657 | 0.4 | 0.4 | 0.4 | 0.4 | 0.4 | 0.4 | 0.4 | 0.4 |
| Cu Omadine | 2.3 | 2.3 | 2.3 | 2.6 | 2.6 | 2.5 | 2.6 | 2.6 |
| TCP | 0.5 | 0.5 | 0.5 | 0.6 | 0.6 | 0.6 | 0.6 | 0.6 |
| Cuprous Oxide | 45.9 | 46.0 | 46.0 | 46.0 | 46.1 | 44.5 | 46.1 | 46.1 |
| Iron Oxide Red | 4.6 | 4.6 | 4.6 | 5.2 | 5.3 | 5.1 | 5.3 | 5.3 |
| ZnO | — | — | — | — | — | 3.3 | — | — |
| Calcium Carbonate | 6.9 | 6.9 | 6.9 | — | — | — | — | — |
| Thixatrol ST | — | — | 0.4 | — | 0.5 | — | — | — |
| Bentone SD-2 | — | 0.4 | — | — | — | — | — | — |
| Bentone SD-3 | — | — | — | — | — | — | 0.4 | — |
| Thixatrol MAX | — | — | — | — | — | — | — | 0.4 |
| MPA 60X | 0.7 | — | — | 0.7 | — | 0.7 | — | — |
| Xylene | 8.9 | 9.0 | 9.0 | 10.2 | 10.2 | 9.9 | 10.2 | 10.2 |
| Totals | 100.0 | 100.0 | 100.0 | 100.0 | 100.0 | 100.0 | 100.0 | 100.0 |

DATA CHART 1

| | Initial | | | | | | | | |
|---|---|---|---|---|---|---|---|---|---|
| Sample ID | Viscosity | 1 | 2 | 3 | 4 | 5 | 6 | 7 | 8 |
| Example 1.1 | 5780 | 1.1 | 4.2 | 2.3 | 4.4 | * | * | * | * |
| Example 1.2 | 3410 | 1.1 | 1.2 | 1.2 | 1.5 | * | * | * | * |
| Example 1.3 | 6540 | 1.5 | 2.0 | 7.0 | * | * | * | * | * |
| Example 1.4 | 2692 | 8.0 | * | * | * | * | * | * | * |
| Example 1.5 | 1944 | 11.8 | 11.7 | 25.2 | * | * | * | * | * |
| Example 1.6 | 2723 | 2.1 | 2.0 | 2.5 | 2.9 | 9.8 | * | * | * |
| Example 1.7 | 1185 | 2.6 | 3.0 | 4.7 | 6.9 | 17.7 | * | * | * |
| Example 1.8 | * | * | * | * | * | * | * | * | * |

* = gelled

### EXAMPLE 2

In this example, a a silyl acrylate binder (poly(triphenylsilyl methacrylate-co-methyl methacrylate) in 50 wt % xylene solution) stabilized with 3 wt % dicyclohexyl carbodiimide) was formulated into test paints with and without maleic anhydride (Table 2) in the same manner as Example 1. The results of the testing of Formulations are shown in Data Chart 2. All percentages are weight percent. Runs 2.1 and 2.2 were prepared under high speed mixing and without maleic anhydride. Both gelled in a week at 55° C. With the increase of maleic anhydride from 1 to 5%, the paint stability increases as shown in the table. There was no skinning or gelation at 55° C. for 8 weeks.

TABLE 2
Test Formulations

| | 2.1 | 2.2 | | | | | | |
|---|---|---|---|---|---|---|---|---|
| Ingredients | Comp. | Comp. | 2.3 | 2.4 | 2.5 | 2.6 | 2.7 | 2.8 |
| Stabilized silyl | 35.4 | 33.6 | 33.9 | 32.6 | 31.9 | 32.1 | 31.8 | 32.1 |
| acrylate binder | | | | | | | | |
| MAP 60X | 0.4 | 0.4 | 0.4 | 0.6 | 0.6 | 0.6 | 0.6 | 0.8 |
| Maleic Anhydride | — | — | 1.2 | 1.0 | 2.1 | 3.0 | 4.1 | 5.0 |
| Lutonal A25 | — | — | — | — | — | — | — | — |
| | | 0.6 | | | | | | |
| NuoSperse 657 | 0.4 | 0.4 | — | 0.5 | 0.5 | 0.5 | 0.5 | 0.5 |
| TCP | 0.2 | — | 0.5 | 0.5 | 0.5 | 0.5 | 0.5 | 0.5 |
| Bentone SD-2 | — | — | 0.4 | — | — | — | — | — |
| Cu Pyrithione | 2.6 | 2.5 | 2.5 | 2.4 | 2.5 | 2.4 | 2.4 | 2.4 |
| Red Iron Oxide | 5.0 | 5.0 | 5.1 | 4.8 | 4.8 | 4.8 | 4.8 | 4.9 |
| Cuprous Oxide | 45.8 | 44.3 | 45.9 | 44.6 | 44.2 | 43.0 | 42.8 | 41.6 |
| Zinc Oxide | 3.3 | 3.3 | — | 3.3 | 3.3 | 3.3 | 3.2 | 3.1 |
| Xylol | 9.9 | 10.0 | 10.1 | 9.7 | 9.5 | 9.8 | 9.5 | 9.3 |
| Total | 100.0 | 100.0 | 100.0 | 100.0 | 100.0 | 100.0 | 100.0 | 100.0 |

DATA CHART 2
Accelerated Storage Test Results

| | Initial | | | | | | | | |
|---|---|---|---|---|---|---|---|---|---|
| Sample ID | Visscosity | 1 | 2 | 3 | 4 | 5 | 6 | 7 | 8 |
| 2.1 | 1453 | 0.6 | * | * | * | * | * | * | * |
| 2.2 | 1392 | 0.4 | * | * | * | * | * | * | * |
| 2.3 | 2585 | 1.3 | 1.6 | 1.9 | 2.5 | 3.7 | 7.2 | 11.7 | 30.9 |
| 2.4 | 2833 | 1.2 | 1.4 | 1.6 | 1.9 | 4.1 | 5.5 | 23.3 | 13.1 |
| 2.5 | 1233 | 1.3 | 1.6 | 1.6 | 2.1 | 2.4 | 2.6 | 3.5 | 4.7 |
| 2.6 | 1425 | 1.3 | 1.5 | 1.6 | 2.0 | 2.4 | 2.8 | 4.0 | 5.3 |
| 2.7 | 1104 | 1.6 | 1.8 | 2.0 | 2.5 | 3.2 | 3.9 | 5.2 | 7.1 |
| 2.8 | 1060 | 1.5 | 2.0 | 2.3 | 3.3 | 5.6 | 11.1 | 20.1 | 75.4 |

### EXAMPLE 3

Samples were prepared (Table 3) and tested (Data Chart 3) as in Example 1. The two most stable paints in this example are Runs #3.1 and 3.3. Both contain maleic anhydride and molecular sieves, and have survived 5-6 weeks at 55° C. Run# 2 has molecular sieves only, and survived 1 week. Similarly, Run #4 has maleic anhydride only, and also survived 1 week.

TABLE 3

| Ingredients | 3.1 | 3.2 | 3.3 | 3.4 | 3.5 |
|---|---|---|---|---|---|
| Stabilized silyl | 38.3 | 35.6 | 37.0 | 38.1 | 35.2 |
| acrylate binder | | | | | |
| TCP | — | 2.1 | 1.0 | — | 2.1 |
| Cab-O-Sil | 0.5 | — | 0.5 | 0.5 | — |
| Bentone SD-2 | — | 0.9 | — | — | 0.8 |
| Bentone 38 | 0.3 | — | 0.5 | 0.3 | — |
| Aerosil | — | 1.1 | — | — | 1.1 |
| Siliporite NK 30* | 1.1 | 1.1 | 1.0 | — | — |
| Talc | 4.8 | 2.2 | 4.6 | 4.8 | 2.1 |
| Iron Oxide Red | 4.7 | 2.7 | 4.6 | 4.8 | 2.7 |
| Titanium Oxide | — | 1.2 | — | — | 1.2 |
| Cuprous Oxide | 33.1 | 35.4 | 32.5 | 33.2 | 35.1 |
| ZnO | — | 5.8 | — | — | 5.7 |
| Zineb | 3.0 | 2.4 | 2.8 | 2.9 | 2.3 |
| Cu Pyrithione | 2.9 | 2.4 | 2.8 | 2.8 | 2.3 |
| Maleic Anhydride | 1.9 | — | 2.0 | 1.9 | — |
| Xylene | 9.5 | 7.3 | 10.7 | 10.8 | 9.5 |
| Totals | 100.0 | 100.0 | 100.0 | 100.0 | 100.0 |

*Powder molecular sieves from Atofina Chemicals, Inc.

DATA CHART 3

| | Initial | | | | | | | | |
|---|---|---|---|---|---|---|---|---|---|
| Sample ID | Viscosity | 1 | 2 | 3 | 4 | 5 | 6 | 7 | 8 |
| 3.1 | 2744 | 2.4 | 3.5 | N/A | 5.2 | N/A | 14.8 | * | * |
| 3.2 | 5460 | 4.3 | * | * | * | * | * | * | * |
| 3.3 | 2348 | 2.2 | 3.9 | N/A | 5.1 | N/A | * | * | * |
| 3.4 | 1920 | 10.4 | * | * | * | * | * | * | * |
| 3.5 | 2616 | * | * | * | * | * | * | * | * |

### EXAMPLE 4

Samples were prepared (Table 4) and tested (Data Chart 4) as in Example 1. The samples contain both maleic anhydride and molecular sieves, except for 4.1 that has only molecular sieves. Example 4 demonstrates the stability testing of paints prepared under high speed mixing using a silyl acrylate binder (poly(triphenylsilyl methacrylate-co-methyl methacrylate-co-n-octyl acrylate) in 50 wt % xylene solution) stabilized with 3 wt % dicyclohexyl carbodiimide.

TABLE 4

| Ingredients | 4.1 | 4.2 | 4.3 | 4.4 | 4.5 |
|---|---|---|---|---|---|
| Stabilized silyl | 37.5 | 37.7 | 34.7 | 34.6 | 35.4 |
| acrylate binder | | | | | |
| TCP | — | — | 1.9 | — | — |
| Cab-O-Sil | 0.5 | 0.5 | — | — | — |
| Bentone SD-2 | — | — | — | — | 0.8 |
| Bentone 38 | 0.3 | 0.3 | — | — | — |
| Aerosil 300 | — | — | 1.0 | 0.6 | 0.5 |
| Siliporite NK 30* | 1.5 | 1.5 | 1.8 | 1.9 | 1.8 |
| Talc | 4.7 | 4.7 | 2.1 | 2.1 | 2.1 |
| Iron Oxide Red | 4.7 | 4.8 | 2.6 | 2.7 | 2.7 |
| Titanium Oxide | — | — | 1.1 | 1.2 | 1.1 |
| Cuprous Oxide | 32.7 | 33.3 | 34.4 | 34.7 | 34.3 |
| ZnO | — | — | 5.7 | 5.8 | 5.7 |
| Zineb | 2.9 | — | 2.3 | 2.3 | — |
| Cu Omadine | 2.8 | 4.6 | 2.2 | 2.3 | 4.6 |
| Maleic Anhydride | 1.9 | 2.0 | — | 2.1 | 2.0 |
| Xylene | 10.6 | 10.7 | 9.3 | 9.5 | 9.3 |
| Totals | 100.0 | 100.0 | 100.0 | 100.0 | 100.0 |

DATA CHART 4

| | Initial | | | | | | | | |
|---|---|---|---|---|---|---|---|---|---|
| Sample ID | Viscosity | 1 | 2 | 3 | 4 | 5 | 6 | 7 | 8 |
| 4.1 | 1310 | 1.1 | 1.2 | 1.3 | 1.4 | 1.5 | 1.6 | 1.6 | 1.6 |
| 4.2 | 938 | 1.5 | 1.4 | 1.7 | 1.7 | 1.8 | 1.6 | 1.6 | 1.7 |
| 4.3 | 4410 | 1.0 | 0.8 | 0.9 | 1.1 | 12 | 1.4 | 1.3 | 2.2 |
| 4.4 | 2025 | 0.9 | 1.1 | 1.2 | 1.1 | 1.0 | 1.1 | 1.1 | 1.2 |
| 4.5 | 2885 | 0.7 | 0.9 | 1.1 | 1.2 | 1.1 | 1.1 | 1.0 | 1.0 |

1. A stabilized coating composition comprising:
a) one or more environmentally sensitive binders; and
b) 0.1 to 10 percent by weight of one or more stabilizers selected from the group consisting of maleic anhydride or a maleic anhydride derivative.

2. The stabilized coating composition of claim 1 wherein said binder is an acrylic binder.

3. The stabilized coating composition of claim 2 wherein said acrylic binder is a silylacrylic binder.

4. The stabilized coating composition of claim 1 wherein said stabilizer comprises maleic anhydride.

5. The stabilized coating composition of claim 1 wherein said environmentally sensitive binder is one capable of undergoing hydrolysis.

6. The stabilized coating composition of claim 1 wherein said stabilizer comprises 0.5 to 5 percent by weight of the coating composition.

7. The stabilized coating composition of claim 1 wherein said composition comprises a marine anti-fouling coating.

8. The stabilized coating composition of claim 1 wherein said composition further comprises 0.001-10 wt percent of molecular sieves.

9. The stabilized coating composition of claim 1 further comprising one or more additives selected from the group consisting of co-binders, rosin, pigments, stabilizers, drying agents, antisagging agents, plasticizers, dispersing agents, thixotropic agents, fillers, biocides, cuprous oxide, and organic co-biocides.

10. A structure exposed to a marine, freshwater, brackish water, or high humidity environment comprising a substrate having directly coated thereon a coating composition comprising one or more environmentally sensitive binders; and from 0.1 to 10 percent by weight of one or more stabilizers selected from the group consisting of maleic anhydride or a maleic anhydride derivative.
